(19) United States
(12) Patent Application Publication
(10) Pub. No.: US 2026/0206522 A1
(43) Pub. Date: Jul. 16, 2026

(54) HEAT TREATMENT METHOD, HEAT TREATMENT SYSTEM, AND HEAT TREATMENT APPARATUS

(71) Applicant: SCREEN Holdings Co., Ltd., Kyoto (JP)

(72) Inventors: Yukio ONO, Kyoto-shi, Kyoto (JP); Takahiro YAMADA, Kyoto-shi, Kyoto (JP); Mao OMORI, Kyoto-shi, Kyoto (JP)

(21) Appl. No.: 18/867,798

(22) PCT Filed: Apr. 21, 2023
(86) PCT No.: PCT/JP2023/015890

§ 371 Date: Nov. 20, 2024

(30) Foreign Application Priority Data
May 24, 2022 (JP) 2022-084237

(51) Int. Cl. H10P 72/00; H05B 1/02

(52) U.S. Cl. CPC H10P 72/0436; H05B 1/0233; H10P 72/0602

(57) ABSTRACT

A first learned regression model is built by machine learning, using a condition on emission of light as an input variable and using an irradiance distribution calculated by an optical simulation as an output variable. A second learned regression model is built by machine learning, using a treatment condition including the irradiance distribution as an input variable and using a temperature distribution of a monitoring wafer actually measured as an output variable. Combining the first learned regression model created based on the optical simulation with the second learned regression model created based on the actual measurement derives a composite function. A temperature distribution occurring in a semiconductor wafer during a light emission heat treatment is predicted based on the composite function.

### BACKGROUND OF THE INVENTION

### Field of the Invention

The present invention relates to a heat treatment method, a heat treatment system, and a heat treatment apparatus which heat a substrate by emitting light to the substrate. Examples of the substrate to be treated include a semiconductor wafer, a substrate for liquid crystal display, a substrate for flat panel display (FPD), a substrate for optical disk, a substrate for magnetic disk, and a substrate for solar cell.

### Description of the Background Art

In processes of manufacturing semiconductor devices, attention is being given to flash lamp annealing (FLA) for heating semiconductor wafers in a very short time period. The flash lamp annealing relates to a heat treatment technology for increasing the temperature of only the front surface of a semiconductor wafer in a very short time period (several milliseconds or shorter) by emitting flashes of light to the front surface using a xenon flash lamp (simply being referred to as “a flash lamp” will mean this xenon flash lamp hereinafter).

The spectral power distribution of xenon flash lamps ranges from the ultraviolet region to the near-infrared region. The light produced by the xenon flash lamps has wavelengths shorter than those of conventional halogen lamps, and almost coincides in fundamental absorption band with semiconductor wafers made of silicon. Thus, when the xenon flash lamp emits flashes of light to the semiconductor wafer, it can rapidly increase the temperature of the semiconductor wafer with less transmitted light. It turns out that temperatures of only the vicinity of the front surface of the semiconductor wafer can be selectively increased with emission of flashes of light in a very short time period of several milliseconds or shorter.

This kind of flash lamp annealing is applied to a treatment requiring heating for a very short time period, for example, typically to activation of impurities injected into semiconductor wafers. When the flash lamp emits flashes of light to the front surface of the semiconductor wafer into which impurities have been injected by an ion injection method, the temperature of the front surface of the semiconductor wafer can be increased to an activation temperature for only a very short time period, which allows only activation of the impurities without deeply diffusing the impurities.

It is important to manage the temperature of a semiconductor wafer in not only the flash lamp annealing but also the heat treatment of the semiconductor wafer. Since the semiconductor wafer is a thin plate substrate, the plane temperature distribution is sometimes nonuniform during heat treatment. Thus, it is necessary to obtain the temperature distribution of the semiconductor wafer during heat treatment. Patent Document 1 discloses obtaining the temperature distribution of a semiconductor wafer during heat treatment in real time by providing a plurality of thermometers.

### PRIOR ART DOCUMENT

### Patent Document

Patent Document 1: Japanese Patent Application Laid-Open No. 2000-188258

### SUMMARY

### Problem to be Solved by the Invention

Although multi-point measurements using many thermometers are required to obtain a detailed temperature distribution of a semiconductor wafer, an actual lamp annealer has difficulty in installing so many thermometers. The temperature distribution of the semiconductor wafer in the lamp annealer is mainly determined by the illuminance distribution of light emitted on the surface of the wafer, and an energy balance between conduction of heat, convection, and radiation that are heat transfer elements. Thus, defining a regression equation using these parameters as input variables and using the temperature distribution as an output variable allows prediction of the temperature distribution of a semiconductor wafer during heat treatment, without providing many thermometers.

Conventionally, attempts to define regression equations have been made by emitting light to monitoring wafers under various conditions and measuring the temperature distributions occurring in the monitoring wafers. The illuminance distribution of light that is an input variable important for defining a regression equation is determined by a power input to lamps mainly included in a device. Typically, a flash lamp annealer includes several tens of lamps. Obtaining many pieces of data while changing the individual setting of the input power for each of the several tens of lamps have required a large number of monitoring wafers.

Impurities are injected into the monitoring wafers for measuring the temperature distributions. Since the impurities are activated by light emission heating, irreversible reactions are generated in the monitoring wafers during heat treatment. Since the monitoring wafers once heated cannot be recycled, many monitoring wafers for obtaining necessary data are consumed. In other words, defining the regression equations has created problems of requiring a great deal of time for repeated light emission treatments in advance, and increase in cost of consuming many monitoring wafers.

Moreover, since obtaining a large amount of data has been difficult, defining a regression equation representing the nonlinearity of the temperature distribution has been difficult, and a regression equation had to be a regression equation using a linear multiple regression. When such a regression equation is used, temperature prediction accuracy in a peripheral portion of a semiconductor wafer in which the nonlinearity particularly strongly appears has been low.

The present invention has been conceived in view of the problems, and the object is to provide a heat treatment method, a heat treatment system, and a heat treatment apparatus which can simply predict the temperature distribution occurring in a substrate with high accuracy.

### Means to Solve the Problem

To solve the problems, a heat treatment method for heating a substrate by emitting light to the substrate according to the first aspect of this invention includes: an irradiance distribution calculation step of calculating an irradiance distribution on a substrate by an optical simulation, based on a condition on emission of light from a lamp; a first learning step of building a first learned model by machine learning, using the condition on the emission of the light as an input variable and using the irradiance distribution calculated by the optical simulation as an output variable; a temperature distribution measuring step of measuring a temperature distribution occurring in a monitoring substrate when the lamp emits the light to the monitoring substrate; a second learning step of building a second learned model by machine learning, using a treatment condition in the temperature distribution measuring step as an input variable and using the temperature distribution measured in the temperature distribution measuring step as an output variable, the treatment condition including the irradiance distribution; a combining step of delivering the irradiance distribution output from the first learned model as a part of the input variable of the second learned model, and combining the first learned model with the second learned model to derive a composite function; and a temperature distribution predicting step of predicting, based on the composite function, a temperature distribution occurring in a substrate to be treated when the lamp emits the light to the substrate to be treated.

Furthermore, the second aspect is that an output of the lamp is controlled based on a temperature prediction value predicted in the temperature distribution predicting step, in the heat treatment method according to the first aspect.

Furthermore, the third aspect is that a treatment condition on the substrate to be treated is determined such that an evaluation function is smallest, the evaluation function being a difference between a target temperature distribution of the substrate to be treated and the temperature distribution predicted in the temperature distribution predicting step, in the heat treatment method according to the first aspect.

A heat treatment system that heats a substrate by emitting light to the substrate according to the fourth aspect includes: an optical simulator that calculates an irradiance distribution on a substrate by an optical simulation, based on a condition on emission of light from a lamp; a first learner that builds a first learned model by machine learning, using the condition on the emission of the light as an input variable and using the irradiance distribution calculated by the optical simulation as an output variable; a temperature distribution measuring instrument that measures a temperature distribution occurring in a monitoring substrate when the lamp emits the light to the monitoring substrate in a heat treatment apparatus; and a second learner that builds a second learned model by machine learning, using a treatment condition when the lamp emits the light to the monitoring substrate as an input variable and using the temperature distribution measured by the temperature distribution measuring instrument as an output variable, the treatment condition including the irradiance distribution, wherein the heat treatment system predicts, based on a composite function, a temperature distribution occurring in a substrate to be treated when the lamp emits the light to the substrate to be treated in the heat treatment apparatus, the composite function being derived by delivering the irradiance distribution output from the first learned model as a part of the input variable of the second learned model and combining the first learned model with the second learned model.

Furthermore, the fifth aspect is that an output of the lamp is controlled based on a temperature prediction value predicted to occur in the substrate to be treated, in the heat treatment system according to the fourth aspect.

Furthermore, the sixth aspect is that a treatment condition on the substrate to be treated is determined such that an evaluation function is smallest, the evaluation function being a difference between a target temperature distribution of the substrate to be treated and a temperature distribution predicted to occur in the substrate to be treated, in the heat treatment system according to the fourth aspect.

A heat treatment apparatus that heats a substrate by emitting light to the substrate according to the seventh aspect includes: a chamber that houses a substrate; a holder that holds the substrate in the chamber; a lamp that emits light to the substrate held by the holder; and a controller that controls an output of the lamp, wherein the controller predicts, based on a composite function, a temperature distribution occurring in a substrate to be treated in the chamber when the lamp emits the light to the substrate to be treated, the composite function being derived by combining a first learned model with a second learned model, the first learned model being built by machine learning using a condition on the emission of the light from the lamp as an input variable and using an irradiance distribution calculated by an optical simulation based on the condition as an output variable, the second learned model being built by machine learning using a treatment condition when the lamp emits the light to a monitoring substrate in the chamber as an input variable and using a temperature distribution occurring in the monitoring substrate as an output variable.

Furthermore, the eighth aspect is that the composite function is derived by delivering the irradiance distribution output from the first learned model as a part of the input variable of the second learned model, and combining the first learned model with the second learned model, in the heat treatment apparatus according to the seventh aspect.

Furthermore, the ninth aspect is that the controller controls an output of the lamp based on a temperature prediction value predicted to occur in the substrate to be treated, in the heat treatment apparatus according to the seventh aspect.

Furthermore, the tenth aspect is that the controller determines a treatment condition on the substrate to be treated such that an evaluation function is smallest, the evaluation function being a difference between a target temperature distribution of the substrate to be treated and a temperature distribution predicted to occur in the substrate to be treated, in the heat treatment apparatus according to the seventh aspect.

### Effects of the Invention

The heat treatment method according to the first to third aspects derives a composite function by combining the first learned model based on the optical simulation with the second learned model based on the actual measurement using a monitoring substrate, and predicts, based on the composite function, a temperature distribution occurring in a substrate to be treated. Thus, consumption of monitoring substrates can be reduced, and the temperature distribution occurring in a substrate can be predicted simply with high accuracy.

The heat treatment system according to the fourth to sixth aspects predicts, based on a composite function, a temperature distribution occurring in a substrate to be treated. The composite function is derived by combining the first learned model based on the optical simulation with the second learned model based on the actual measurement using a monitoring substrate. Thus, consumption of monitoring substrates can be reduced, and the temperature distribution occurring in a substrate can be predicted simply with high accuracy.

The heat treatment apparatus according to the seventh to tenth aspects predicts, based on a composite function, a temperature distribution occurring in a substrate to be treated. The composite function is derived by combining the first learned model based on the optical simulation with the second learned model based on the actual measurement using a monitoring substrate. Thus, consumption of monitoring substrates can be reduced, and the temperature distribution occurring in a substrate can be predicted simply with high accuracy.

### BRIEF DESCRIPTION OF THE DRAWINGS

FIG. 1 illustrates an example structure of a heat treatment system according to the present invention.

FIG. 2 is a longitudinal sectional view illustrating a structure of the heat treatment apparatus.

FIG. 3 is a perspective view illustrating the entire external appearance of a holder.

FIG. 4 is a plan view of a susceptor.

FIG. 5 is a sectional view of the susceptor.

FIG. 6 is a plan view of a transfer mechanism.

FIG. 7 is a side view of the transfer mechanism.

FIG. 8 is a plan view illustrating an arrangement of multiple halogen lamps.

FIG. 9 is a block diagram illustrating a configuration of a controller.

FIG. 10 is a flowchart illustrating a procedure for building the first learned regression model.

FIG. 11 is a flowchart illustrating a procedure for building the second learned regression model.

FIG. 12 is a flowchart illustrating a procedure for combining and using the first learned regression model and the second learned regression model.

FIG. 13 conceptually illustrates the entire treatment details of the heat treatment system.

### DESCRIPTION OF THE PREFERRED EMBODIMENTS

Hereinafter, an embodiment of the present invention will be described in detail with reference to the drawings. Unless otherwise specified, the expressions indicating relative or absolute positional relationships (e.g., “in one direction”, “along one direction”, “parallel”, “orthogonal”, “central”, “concentric”, and “coaxial”) in the following description include those exactly indicating the positional relationships and those where an angle or a distance is relatively displaced within tolerance or to the extent that similar functions can be obtained. Unless otherwise specified, the expressions indicating equality (e.g., “same”, “equal”, and “homogeneous”) include those indicating quantitatively exact equality and those in the presence of a difference within tolerance or to the extent that similar functions can be obtained. Unless otherwise specified, the expressions indicating shapes (e.g., “circular”, “rectangular”, or “cylindrical”) include those indicating geometrically exact shapes and those indicating shapes to the extent that similar advantages can be obtained, for example, roughness or a chamfer. An expression “comprising”, “including”, “containing”, or “having” a certain constituent element is not an exclusive expression for excluding the presence of the other constituent elements. An expression “at least one of A, B, or C” involves “only A”, “only B”, “only C”, “arbitrary two of A, B, and C”, and “all of A, B, and C”.

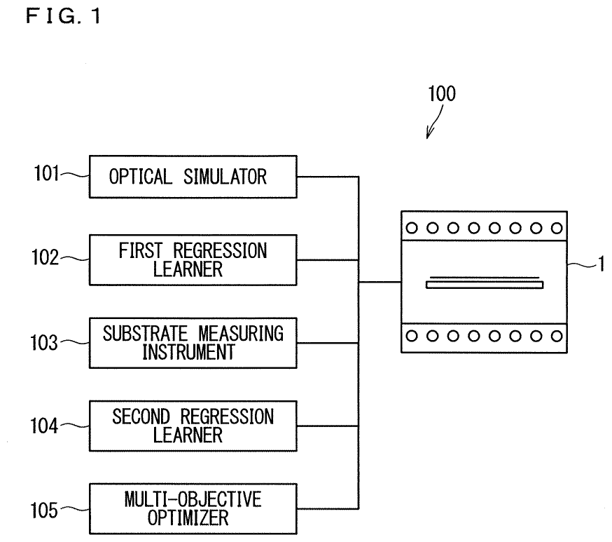

FIG. 1 illustrates an example structure of a heat treatment system 100 according to the present invention. The heat treatment system 100 includes a heat treatment apparatus 1, an optical simulator 101, a first regression learner 102, a substrate measuring instrument 103, a second regression learner 104, and a multi-objective optimizer 105. It should be noted that dimensions and the number of components in FIG. 1 and the subsequent drawings are shown in exaggeration or in simplified form as appropriate for the sake of easier understanding.

The heat treatment apparatus 1 emits light to a semiconductor wafer W to heat the semiconductor wafer W. The optical simulator 101 obtains an irradiance distribution of the front surface of the semiconductor wafer W by executing optical simulation software. The first regression learner 102 builds a first learned regression model for obtaining the irradiance distribution of the front surface of the semiconductor wafer W through machine learning. The substrate measuring instrument 103 measures a surface resistance value (a sheet resistance value) of a monitoring wafer after a light emission heat treatment. The second regression learner 104 builds a second learned regression model for obtaining the temperature distribution of the front surface of the semiconductor wafer W through machine learning. The multi-objective optimizer 105 executes multi-objective optimization to determine treatment conditions on the semiconductor wafer W to be treated. The details of these elements will be further described later.

Each of the optical simulator 101, the first regression learner 102, the second regression learner 104, and the multi-objective optimizer 105 among the elements of the heat treatment system 100 is implemented by causing a typical computer to execute predetermined software.

The heat treatment apparatus 1, the optical simulator 101, the first regression learner 102, the substrate measuring instrument 103, the second regression learner 104, and the multi-objective optimizer 105 are mutually connected online to enable reception and transmission of data. Furthermore, a generally-called cloud system may be built by storing data in one server so that the heat treatment apparatus 1, the optical simulator 101, the first regression learner 102, the substrate measuring instrument 103, the second regression learner 104, and the multi-objective optimizer 105 use the data. Alternatively, data may be received and transmitted through a recording medium by making at least one of the heat treatment apparatus 1, the optical simulator 101, the first regression learner 102, the substrate measuring instrument 103, the second regression learner 104, or the multi-objective optimizer 105 offline.

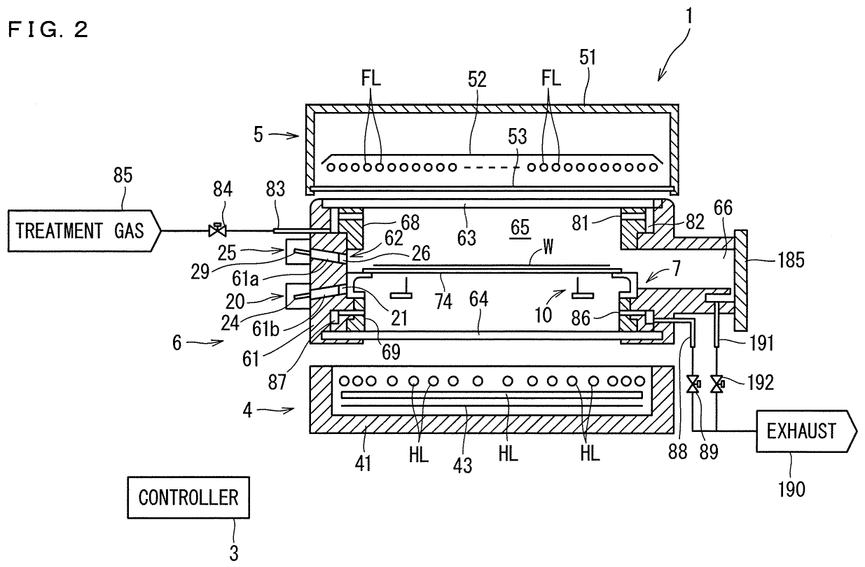

FIG. 2 is a longitudinal sectional view illustrating a structure of the heat treatment apparatus 1. The heat treatment apparatus 1 in FIG. 2 is a flash lamp annealer that heats the disk-shaped semiconductor wafer W serving as a substrate by emitting flashes of light to the semiconductor wafer W. The size of the semiconductor wafer W to be treated is, but not particularly limited to, for example, φ 300 mm or φ 450 mm (φ 300 mm in this embodiment).

The heat treatment apparatus 1 includes a chamber 6 that houses the semiconductor wafer W, a flash heater 5 including a plurality of flash lamps FL, and a halogen heater 4 including a plurality of halogen lamps HL. The flash heater 5 is provided above the chamber 6, and the halogen heater 4 is provided below the chamber 6. The heat treatment apparatus 1 also includes, within the chamber 6, a holder 7 that holds the semiconductor wafer W in a horizontal attitude, and a transfer mechanism 10 that transfers the semiconductor wafer W between the holder 7 and the outside of the apparatus. The heat treatment apparatus 1 further includes a controller 3 that controls operating mechanisms located in the halogen heater 4, the flash heater 5, and the chamber 6 to execute a heat treatment of the semiconductor wafer W.

The chamber 6 includes quartz chamber windows attached to the top and the bottom of a chamber side portion 61 that is tubular. The chamber side portion 61 is substantially tubular with the top and the bottom being opened. The top opening has a top chamber window 63 that is mounted and closed, and the bottom opening has a bottom chamber window 64 that is mounted and closed. The top chamber window 63, which is a ceiling portion of the chamber 6, is a disk-shaped part made of quartz, and functions as a quartz window that allows the flashes of light emitted from the flash heater 5 to pass through the chamber 6. The bottom chamber window 64, which is a floor of the chamber 6, is a disc-shaped member made of quartz and functions as a quartz window that allows light emitted from the halogen heater 4 to pass through the chamber 6.

A reflection ring 68 is mounted on the upper portion of the inner wall surface of the chamber side portion 61, and a reflection ring 69 is mounted on the lower portion thereof. Both of the reflection rings 68 and 69 are formed annular. The upper reflection ring 68 is fitted from above the chamber side portion 61. On the other hand, the lower reflection ring 69 is fitted from below the chamber side portion 61 and fastened with screws whose illustration is omitted. In other words, the reflection rings 68 and 69 are both removably mounted on the chamber side portion 61. An interior space of the chamber 6, i.e. a space surrounded by the top chamber window 63, the bottom chamber window 64, the chamber side portion 61, and the upper and lower reflection rings 68 and 69, is defined as a heat treatment space 65.

A recessed portion 62 is formed in the inner wall surface of the chamber 6 by fitting the reflection rings 68 and 69 to the chamber side portion 61. In other words, the recessed portion 62 is formed by being surrounded by a central portion of the inner wall surface of the chamber side portion 61 to which the reflection rings 68 and 69 are not fitted, a lower end face of the reflection ring 68, and an upper end face of the reflection ring 69. The recessed portion 62 is formed annular in a horizontal direction along the inner wall surface of the chamber 6, and surrounds the holder 7 that holds the semiconductor wafer W. The chamber side portion 61 and the reflection rings 68 and 69 are made of a metal material (e.g., stainless steel) superior in strength and heat resistance.

The chamber side portion 61 has a transport opening (throat) 66 through which the semiconductor wafer W is transported into and out of the chamber 6. The transport opening 66 is openable and closable with a gate valve 185. The transport opening 66 is connected in communication with an outer peripheral surface of the recessed portion 62. Thus, when the transport opening 66 is opened by the gate valve 185, the semiconductor wafer W can be transported into and out of the heat treatment space 65 through the transport opening 66 and the recessed portion 62. When the transport opening 66 is closed by the gate valve 185, the heat treatment space 65 in the chamber 6 is made airtight.

The chamber side portion 61 is further provided with a through hole 61a and a through hole 61b both bored therein. The through hole 61a is a cylindrical hole for directing infrared light radiated from an upper surface of the semiconductor wafer W held by a susceptor 74 to be described later, to an infrared sensor 29 of an upper radiation thermometer 25. The through hole 61b is a cylindrical hole for directing infrared light irradiated from a lower surface of the semiconductor wafer W, to an infrared sensor 24 of a lower radiation thermometer 20. The through holes 61a and 61b are inclined with respect to the horizontal direction such that axes of the through holes 61a and 61b in the penetrating direction intersect with a main surface of the semiconductor wafer W held by the susceptor 74. A transparent window 26 made of calcium fluoride transparent to infrared light in a wavelength region measurable with the upper radiation thermometer 25 is mounted to an end portion of the through hole 61a which faces the heat treatment space 65. A transparent window 21 made of barium fluoride transparent to infrared light in a wavelength region measurable with the lower radiation thermometer 20 is mounted to an end portion of the through hole 61b which faces the heat treatment space 65.

A gas supply opening 81 for supplying the heat treatment space 65 with a treatment gas is formed in an upper portion of the inner wall of the chamber 6. The gas supply opening 81 is formed above the recessed portion 62, and may be provided in the reflection ring 68. The gas supply opening 81 is connected in communication with a gas supply pipe 83 through a buffer space 82 formed annular inside the side wall of the chamber 6. The gas supply pipe 83 is connected to a treatment gas supply source 85. A valve 84 is inserted at some midpoint in the gas supply pipe 83. When the valve 84 is opened, the treatment gas is fed from the treatment gas supply source 85 to the buffer space 82. The treatment gas flowing in the buffer space 82 flows to be spread within the buffer space 82 lower in fluid resistance than the gas supply opening 81, and is supplied into the heat treatment space 65 through the gas supply opening 81. Examples of the treatment gas can include inert gases such as nitrogen (N₂), reactive gases such as hydrogen (H₂) and ammonia (NH₃), and mixed gases that are mixtures of these gases (nitrogen gas in this embodiment).

A gas exhaust opening 86 for exhausting gas in the heat treatment space 65 is formed in a lower portion of the inner wall of the chamber 6. The gas exhaust opening 86 is formed below the recessed portion 62, and may be provided in the reflection ring 69. The gas exhaust opening 86 is connected in communication with a gas exhaust pipe 88 through a buffer space 87 formed annular inside the side wall of the chamber 6. The gas supply pipe 88 is connected to an exhaust part 190. A valve 89 is inserted at some midpoint in the gas exhaust pipe 88. When the valve 89 is opened, the gas in the heat treatment space 65 is exhausted to the gas exhaust pipe 88 through the gas exhaust opening 86 and the buffer space 87. The gas supply opening 81 and the gas exhaust opening 86 may be formed in a plurality of portions in a circumferential direction of the chamber 6, and may be slits. The treatment gas supply source 85 and the exhaust part 190 may be mechanisms provided in the heat treatment apparatus 1, or utilities in a factory in which the heat treatment apparatus 1 is installed.

A gas exhaust pipe 191 for exhausting the gas in the heat treatment space 65 is also connected to an end of the transport opening 66. The gas exhaust pipe 191 is connected to the exhaust part 190 through a valve 192. By opening the valve 192, the gas in the chamber 6 is exhausted through the transport opening 66.

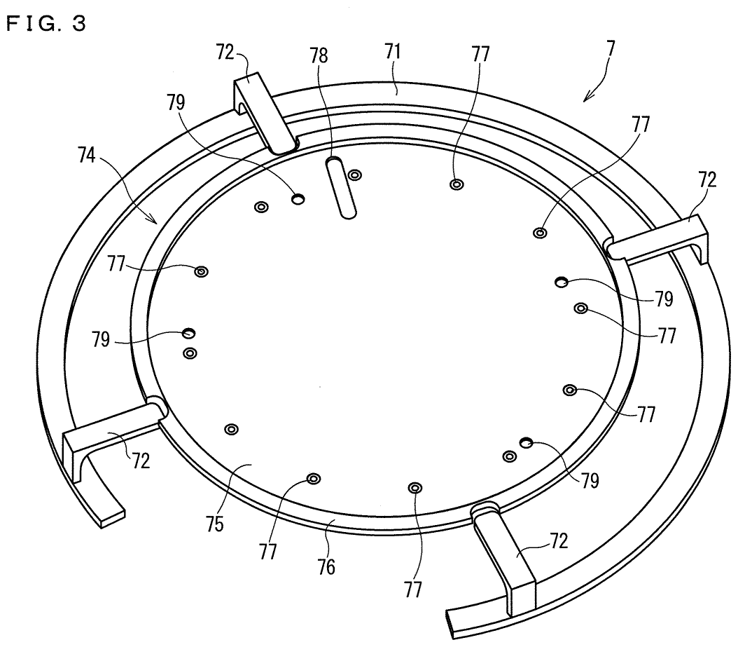

FIG. 3 is a perspective view illustrating the entire external appearance of the holder 7. The holder 7 includes a base ring 71, coupling portions 72, and the susceptor 74. The base ring 71, the coupling portions 72, and the susceptor 74 are all made of quartz. In other words, the whole of the holder 7 is made of quartz.

The base ring 71 is a quartz part having an arcuate shape obtained by removing a portion from an annular shape. This removed portion is provided to prevent interference between transfer arms 11 of the transfer mechanism 10 to be described later and the base ring 71. The base ring 71 is supported by the wall surface of the chamber 6 by being placed on the bottom surface of the recessed portion 62 (see FIG. 2). The multiple coupling portions 72 (four in this embodiment) are mounted upright on the upper surface of the base ring 71 and arranged in a circumferential direction of the annular shape thereof. The coupling portions 72 are quartz parts, and are rigidly secured to the base ring 71 by welding.

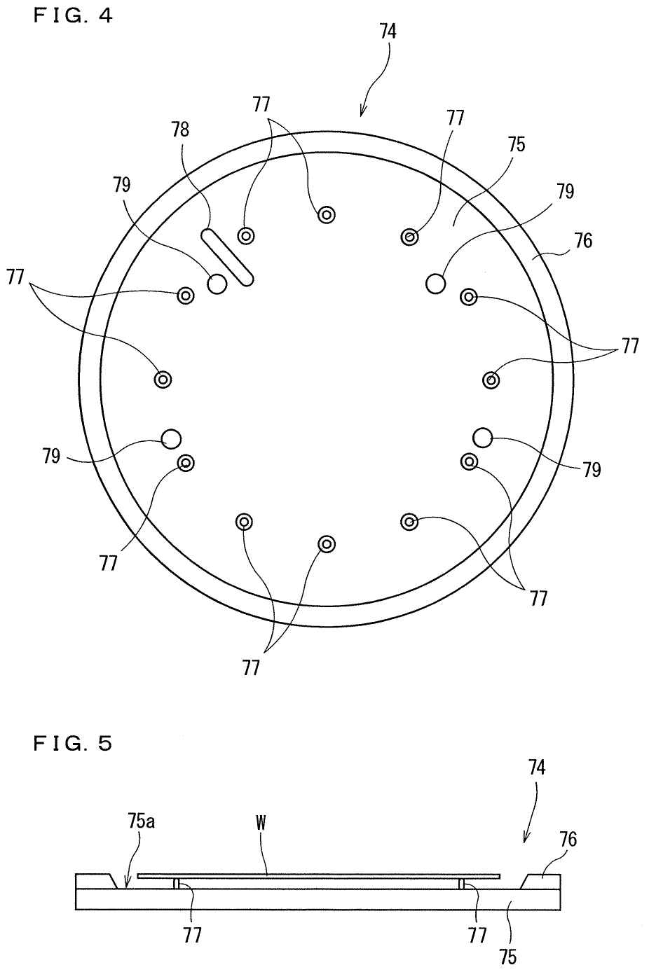

The susceptor 74 is supported by the four coupling portions 72 provided on the base ring 71. FIG. 4 is a plan view of the susceptor 74. FIG. 5 is a sectional view of the susceptor 74. The susceptor 74 includes a holding plate 75, a guide ring 76, and a plurality of substrate support pins 77. The holding plate 75 is a roughly circular and planar part made of quartz. The diameter of the holding plate 75 is greater than that of the semiconductor wafer W. In other words, the holding plate 75 is greater in plan size than the semiconductor wafer W.

The guide ring 76 is provided on a peripheral portion of the upper surface of the holding plate 75. The guide ring 76 is an annular part having an inner diameter greater than the diameter of the semiconductor wafer W. For example, when the diameter of the semiconductor wafer W is φ 300 mm, the inner diameter of the guide ring 76 is φ 320 mm. The inner periphery of the guide ring 76 is a tapered surface which becomes wider upward from the holding plate 75. The guide ring 76 is made of quartz similar to that of the holding plate 75. The guide ring 76 may be welded to the upper surface of the holding plate 75 or fixed to the holding plate 75 with, for example, separately machined pins. Alternatively, the holding plate 75 and the guide ring 76 may be machined as an integral part.

A region of the upper surface of the holding plate 75 which is inside the guide ring 76 serves as a planar holding surface 75a for holding the semiconductor wafer W. The plurality of substrate support pins 77 are mounted upright on the holding surface 75a of the holding plate 75. In this embodiment, a total of 12 substrate support pins 77 are mounted upright at intervals of 30 degrees along the circumference of a circle concentric with the outer circumference of the holding surface 75a (the inner circumference of the guide ring 76). The diameter of the circle on which the 12 substrate support pins 77 are disposed (the distance between opposed ones of the substrate support pins 77) is smaller than the diameter of the semiconductor wafer W, and is φ 270 mm to φ 280 mm (φ 270 mm in this embodiment) when the diameter of the semiconductor wafer W is φ 300 mm. Each of the substrate support pins 77 is made of quartz. The substrate support pins 77 may be provided by welding on the upper surface of the holding plate 75 or machined integrally with the holding plate 75.

Referring again to FIG. 3, the four coupling portions 72 mounted upright on the base ring 71 are rigidly secured to the peripheral portion of the holding plate 75 of the susceptor 74 by welding. In other words, the susceptor 74 and the base ring 71 are fixedly coupled to each other with the coupling portions 72. The base ring 71 of the holder 7 is supported by the wall surface of the chamber 6, whereby the holder 7 is mounted to the chamber 6. With the holder 7 being mounted to the chamber 6, the holding plate 75 of the susceptor 74 assumes a horizontal attitude (an attitude such that the normal to the susceptor 74 coincides with a vertical direction). In other words, the holding surface 75a of the holding plate 75 becomes a horizontal plane.

The semiconductor wafer W transported into the chamber 6 is placed and held in a horizontal attitude on the susceptor 74 of the holder 7 mounted to the chamber 6. At this time, the semiconductor wafer W is supported by the 12 substrate support pins 77 mounted upright on the holding plate 75, and is held by the susceptor 74. More strictly speaking, upper end portions of the 12 substrate support pins 77 are in contact with the lower surface of the semiconductor wafer W to support the semiconductor wafer W. The semiconductor wafer W can be supported in a horizontal attitude by the 12 substrate support pins 77 because the 12 substrate support pins 77 have a uniform height (a distance from the upper ends of the substrate support pins 77 to the holding surface 75a of the holding plate 75).

The semiconductor wafer W supported by the substrate support pins 77 is spaced a predetermined distance apart from the holding surface 75a of the holding plate 75. The thickness of the guide ring 76 is greater than the height of the substrate support pins 77. Thus, the guide ring 76 prevents the horizontal misregistration of the semiconductor wafer W supported by the substrate support pins 77.

As illustrated in FIGS. 3 and 4, an opening 78 is formed to vertically penetrate the susceptor 74 in the holding plate 75 of the susceptor 74. The opening 78 is provided for the lower radiation thermometer 20 to receive light (infrared light) radiated from the lower surface of the semiconductor wafer W. Specifically, the lower radiation thermometer 20 receives the light radiated from the lower surface of the semiconductor wafer W through the opening 78 and the transparent window 21 mounted to the through hole 61b in the chamber side portion 61 to measure the temperature of the semiconductor wafer W. The holding plate 75 of the susceptor 74 includes four through holes 79 which allow lift pins 12 of the transfer mechanism 10 to be described later to penetrate for transferring the semiconductor wafer W.

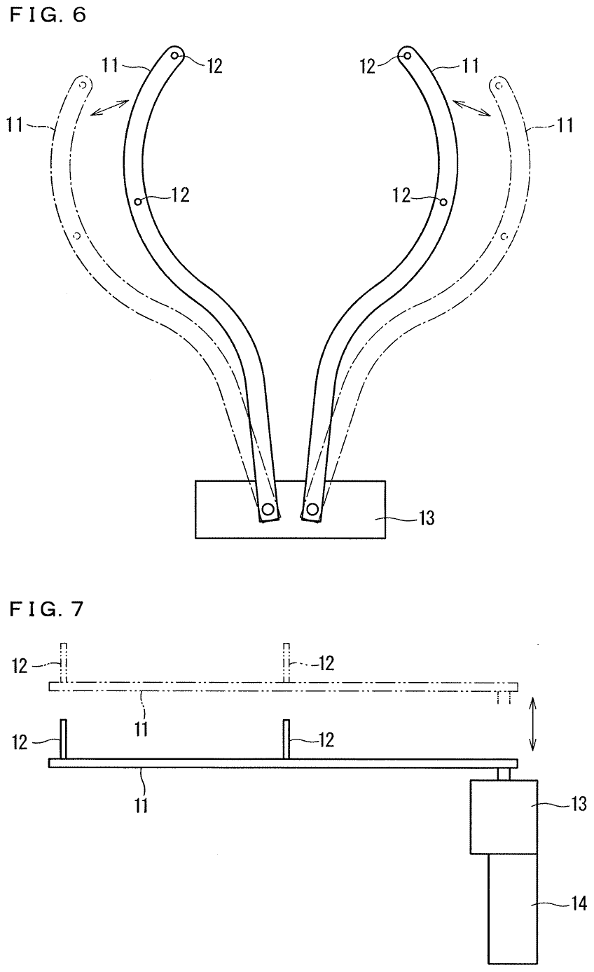

FIG. 6 is a plan view of the transfer mechanism 10. FIG. 7 is a side view of the transfer mechanism 10. The transfer mechanism 10 includes the two transfer arms 11. The transfer arms 11 have an arcuate shape to fit the recessed portion 62 that is roughly annular. Each of the transfer arms 11 includes the two lift pins 12 mounted upright thereon. The transfer arms 11 and the lift pins 12 are made of quartz. The transfer arms 11 are pivotable by a horizontal movement mechanism 13. The horizontal movement mechanism 13 horizontally moves the pair of transfer arms 11 between a transfer operation position (a position indicated by solid lines in FIG. 6) in which the semiconductor wafer W is transferred to and from the holder 7 and a retracted position (a position indicated by dash-double-dot lines in FIG. 6) in which the transfer arms 11 do not overlap the semiconductor wafer W held by the holder 7 in a plan view. The horizontal movement mechanism 13 may cause individual motors to pivot the respective transfer arms 11. Alternatively, a linkage mechanism may cause a single motor to pivot the pair of transfer arms 11 in a cooperative manner.

An elevating mechanism 14 moves the pair of transfer arms 11 upward and downward together with the horizontal movement mechanism 13. When the elevating mechanism 14 moves the pair of transfer arms 11 upward at their transfer operation position, the four lift pins 12 in total pass through the respective four through holes 79 (see FIGS. 3 and 4) bored in the susceptor 74 so that the upper ends of the lift pins 12 protrude from the upper surface of the susceptor 74. On the other hand, when the elevating mechanism 14 moves the pair of transfer arms 11 downward at their transfer operation position to take the lift pins 12 out of the respective through holes 79 and the horizontal movement mechanism 13 moves the pair of transfer arms 11 to be opened, the pair of the transfer arms 11 moves to their retracted position. The retracted position of the pair of transfer arms 11 is immediately over the base ring 71 of the holder 7. The retracted position of the transfer arms 11 is inside the recessed portion 62 because the base ring 71 is placed on the bottom surface of the recessed portion 62. An exhaust mechanism that is not illustrated is also provided near the location where the drivers (the horizontal movement mechanism 13 and the elevating mechanism 14) of the transfer mechanism 10 are provided, and is configured to exhaust an atmosphere around the drivers of the transfer mechanism 10 to the outside of the chamber 6.

Referring again to FIG. 2, the flash heater 5 provided over the chamber 6 includes, inside an enclosure 51, a light source including the multiple (30 in this embodiment) xenon flash lamps FL, and a reflector 52 to cover the upper portion of the light source. The flash heater 5 further includes a lamp light radiation window 53 mounted at the bottom of the enclosure 51. The lamp light radiation window 53 forming the floor of the flash heater 5 is a plate-like quartz window made of quartz. The flash heater 5 is provided over the chamber 6, whereby the lamp light radiation window 53 is opposed to the top chamber window 63. The flash lamps FL emit flashes of light to the heat treatment space 65 from over the chamber 6 through the lamp light radiation window 53 and the top chamber window 63.

The plurality of flash lamps FL, each of which is a rod-shaped lamp having an elongated cylindrical shape, are arranged in a plane so that the longitudinal directions of the respective flash lamps FL are in parallel with each other along the main surface (that is, in a horizontal direction) of the semiconductor wafer W held by the holder 7. Thus, a plane defined by the arrangement of the flash lamps FL is also a horizontal plane.

The xenon flash lamp FL includes a rod-shaped glass tube (discharge tube) containing xenon gas sealed therein and having positive and negative electrodes at both ends that are connected to a capacitor, and a trigger electrode attached to the outer peripheral surface of the glass tube. Even if charges are accumulated in the capacitor, no electricity will flow through the glass tube in a normal state because the xenon gas is an electrical insulator. However, when a high voltage is applied to the trigger electrode to cause an electrical breakdown, the electricity accumulated in the capacitor momentarily flows through the glass tube, so that excitation of xenon atoms or molecules at this time causes light to be emitted. Since the electrostatic energy accumulated in advance in the capacitor of the xenon flash lamp FL is transformed into very short light pulses ranging from 0.1 to 100 milliseconds, the xenon flash lamp FL is characterized by the possibility of emitting more intense light than the continuous lighting light source such as the halogen lamps HL. In other words, the xenon flash lamp FL is a pulse emitting lamp that momentarily emits light in a very short time period less than one second. The light emission time of the flash lamps FL can be adjusted by a coil constant of a lamp light source that supplies power to the flash lamps FL.

The reflector 52 is provided over the plurality of flash lamps FL to cover all of the flash lamps FL. The basic function of the reflector 52 is to reflect the flashes of light emitted from the plurality of flash lamps FL to the heat treatment space 65. The reflector 52 is a plate made of an aluminum alloy. A surface of the reflector 52 (a surface which faces the flash lamps FL) is roughened by abrasive blasting.

The halogen heater 4 provided under the chamber 6 includes, inside an enclosure 41, the multiple (40 in this embodiment) halogen lamps HL. The halogen heater 4 emits light to the heat treatment space 65 from under the chamber 6 through the bottom chamber window 64 to heat the semiconductor wafer W by means of the halogen lamps HL.

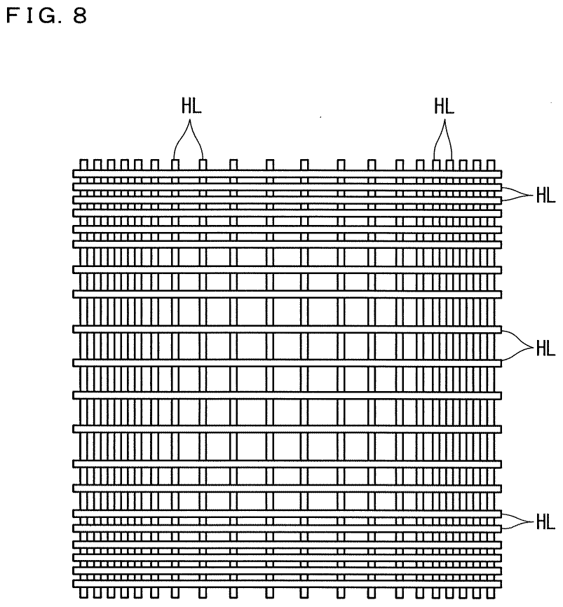

FIG. 8 is a plan view illustrating an arrangement of the multiple halogen lamps HL. The 40 halogen lamps HL are arranged in two upper and lower tiers. 20 halogen lamps HL are arranged in the upper tier closer to the holder 7, and 20 halogen lamps HL are arranged in the lower tier farther from the holder 7 than the upper tier. Each of the halogen lamps HL is a rod-shaped lamp having an elongated cylindrical shape. The 20 halogen lamps HL in each of the upper tier and the lower tier are arranged so that the longitudinal directions thereof are in parallel with each other along the main surface of the semiconductor wafer W held by the holder 7 (that is, in a horizontal direction). Thus, a plane defined by the arrangement of the halogen lamps HL in each of the upper and lower tiers is a horizontal plane.

As illustrated in FIG. 8, the halogen lamps HL in each of the upper and lower tiers are disposed at a higher density in regions facing the peripheral portion of the semiconductor wafer W held by the holder 7 than that in a region facing the central portion thereof. In other words, the halogen lamps HL in each of the upper and lower tiers are arranged at shorter intervals in the peripheral portions of the lamp arrangement than that in the central portion thereof. Thus, a greater amount of light can impinge upon the peripheral portion of the semiconductor wafer W which is subject to a temperature decrease when the semiconductor wafer W is heated by the halogen heater 4 through light emission.

The group of halogen lamps HL in the upper tier and the group of halogen lamps HL in the lower tier are arranged to intersect each other in a lattice pattern. In other words, the 40 halogen lamps HL in total are disposed so that the longitudinal direction of the 20 halogen lamps HL arranged in the upper tier and the longitudinal direction of the 20 halogen lamps HL arranged in the lower tier are orthogonal to each other.

Each of the halogen lamps HL is a filament-type light source which passes a current through a filament disposed in a glass tube to make the filament incandescent, thereby emitting light. A gas prepared by introducing a halogen element (e.g., iodine or bromine) in trace amounts into an inert gas such as nitrogen or argon is sealed in the glass tube. The introduction of the halogen element allows the temperature of the filament to be set at a high temperature while suppressing a break in the filament. Thus, the halogen lamps HL are characterized by having a longer life than typical incandescent lamps and being capable of continuously emitting intense light. In other words, the halogen lamps HL are continuous lighting lamps that emit light continuously for at least one second or longer. In addition, the halogen lamps HL, which are rod-shaped lamps, have a long life. The arrangement of the halogen lamps HL in a horizontal direction exhibits superior radiation efficiency toward the semiconductor wafer W provided over the halogen lamps HL.

A reflector 43 is provided also inside the enclosure 41 of the halogen heater 4 under the halogen lamps HL arranged in two tiers (FIG. 2). The reflector 43 reflects the light emitted from the plurality of halogen lamps HL toward the heat treatment space 65.

As illustrated in FIG. 2, the chamber 6 includes two radiation thermometers (pyrometers in this embodiment) of the upper radiation thermometer 25 and the lower radiation thermometer 20. The upper radiation thermometer 25 is provided obliquely above the semiconductor wafer W held by the susceptor 74, and measures the temperature of the upper surface of the semiconductor wafer W by receiving the infrared light radiated from the upper surface of the semiconductor wafer W. The infrared sensor 29 of the upper radiation thermometer 25 includes an optical element made of InSb (indium antimonide) so as to be able to respond to rapid changes in temperature of the upper surface of the semiconductor wafer W at the moment of emission of flashes of light. On the other hand, the lower radiation thermometer 20 is provided obliquely below the semiconductor wafer W held by the susceptor 74, and measures the temperature of the lower surface of the semiconductor wafer W by receiving the infrared light radiated from the lower surface of the semiconductor wafer W.

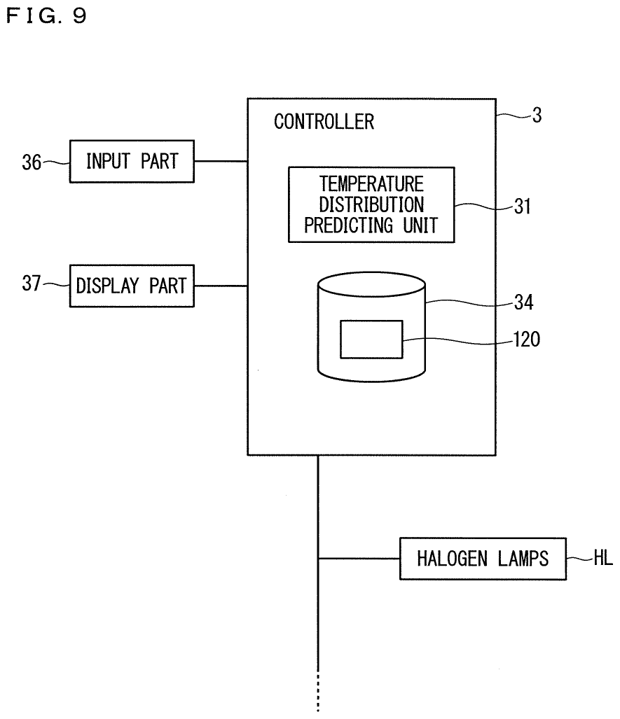

The controller 3 controls the aforementioned various operating mechanisms provided in the heat treatment apparatus 1. FIG. 9 is a block diagram illustrating a configuration of the controller 3. The controller 3 is similar in hardware configuration to a typical computer. In other words, the controller 3 includes a CPU that is a circuit for performing various computation processes, a ROM or read-only memory for storing a basic program, a RAM or readable/writable memory for storing various pieces of information, and a storage 34 (e.g., a magnetic disk) for storing, for example, control software and data. The CPU in the controller 3 executes a predetermined processing program, so that the treatment in the heat treatment apparatus 1 will proceed.

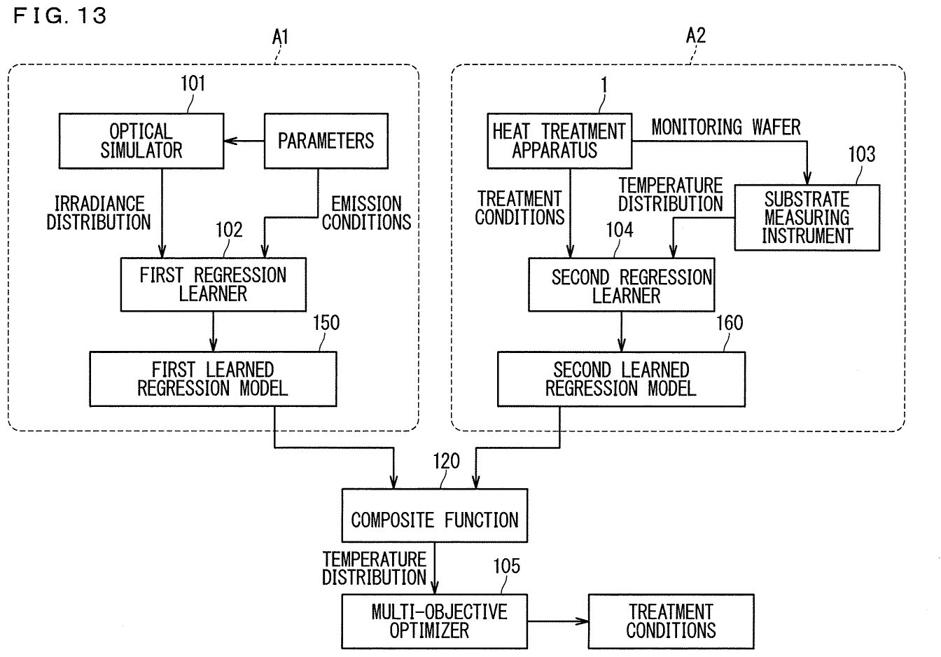

The controller 3 includes a temperature distribution predicting unit 31. The temperature distribution predicting unit 31 is a function processor that is implemented by causing a CPU of the controller 3 to execute a predetermined processing program. The processing details of the temperature distribution predicting unit 31 will be further described later. Furthermore, the storage 34 of the controller 3 stores a composite function 120 (FIG. 13) created by combining the first learned regression model with the second learned regression model.

The elements such as the halogen lamps HL are electrically connected to the controller 3. The controller 3 controls the output from the halogen lamps HL (strictly speaking, controls the power source that supplies power to the halogen lamps HL).

Furthermore, a display part 37 and an input part 36 are connected to the controller 3. The display part 7 and the input part 36 function as user interfaces of the heat treatment apparatus 1. The controller 3 displays a variety of pieces of information on the display part 37. An operator of the heat treatment apparatus 1 can input various commands and parameters from the input part 36 while viewing the information displayed on the display part 37. A keyboard and a mouse, for example, may be used as the input part 36. A liquid crystal display, for example, may be used as the display part 37. In this embodiment, a liquid crystal touch panel provided on an outer wall of the heat treatment apparatus 1 is used to function as both of the display part 37 and the input part 36.

The heat treatment apparatus 1 further includes, in addition to the aforementioned structures, various cooling structures to prevent an excessive temperature rise in the halogen heater 4, the flash heater 5, and the chamber 6 due to the heat energy generated from the halogen lamps HL and the flash lamps FL during the heat treatment of the semiconductor wafer W. For example, a water-cooling tube (not illustrated) is provided in the walls of the chamber 6. Also, the halogen heater 4 and the flash heater 5 have an air cooling structure for generating a gas flow therein to exhaust heat. Air is supplied to a gap between the top chamber window 63 and the lamp light radiation window 53 to cool down the flash heater 5 and the top chamber window 63.

Next, treatment details of the heat treatment system 100 will be described. First, treatments on the normal semiconductor wafer W in the heat treatment apparatus 1 will be described. The procedure for treating the semiconductor wafer W will proceed by controlling various operating mechanisms of the heat treatment apparatus 1 using the controller 3.

The valve 84 for supply of gas is opened prior to the treatment of the semiconductor wafer W, and the valve 89 for exhaust of gas is opened, so that the supply and exhaust of gas into and out of the chamber 6 start. When the valve 84 is opened, nitrogen gas is supplied from the gas supply opening 81 into the heat treatment space 65. When the valve 89 is opened, the gas within the chamber 6 is exhausted through the gas exhaust opening 86. This causes the nitrogen gas supplied from an upper portion of the heat treatment space 65 in the chamber 6 to flow downward and then to be exhausted from a lower portion of the heat treatment space 65.

The gas within the chamber 6 is exhausted also through the transport opening 66 by opening the valve 192. Further, the exhaust mechanism that is not illustrated exhausts an atmosphere near the drivers of the transfer mechanism 10. The nitrogen gas is continuously supplied into the heat treatment space 65 during the heat treatment of the semiconductor wafer W in the heat treatment apparatus 1. The supplied amount of nitrogen gas is changed as appropriate in accordance with process steps.

Subsequently, the gate valve 185 is opened to open the transport opening 66. A transport robot outside the heat treatment apparatus 1 transports the semiconductor wafer W to be treated into the heat treatment space 65 of the chamber 6 through the transport opening 66. At this time, there is a danger that an atmosphere outside the heat treatment apparatus 1 is carried as the semiconductor wafer W is transported. However, the nitrogen gas is continuously supplied into the chamber 6. Thus, the nitrogen gas flows out of the transport opening 66 to minimize the carried outside atmosphere.

The semiconductor wafer W transported by the transport robot is moved forward to a position lying immediately over the holder 7 and is stopped. Then, the pair of transfer arms 11 of the transfer mechanism 10 is moved horizontally from the retracted position to the transfer operation position and is then moved upward, whereby the lift pins 12 pass through the through holes 79 and protrude from the upper surface of the holding plate 75 of the susceptor 74 to receive the semiconductor wafer W. At this time, the lift pins 12 move upward above the upper ends of the substrate support pins 77.

After the semiconductor wafer W is placed on the lift pins 12, the transport robot moves out of the heat treatment space 65, and the gate valve 185 closes the transport opening 66. Then, the pair of transfer arms 11 moves downward to transfer the semiconductor wafer W from the transfer mechanism 10 to the susceptor 74 of the holder 7, so that the semiconductor wafer W is held in a horizontal attitude. The semiconductor wafer W is supported by the plurality of substrate support pins 77 mounted upright on the holding plate 75, and is held by the susceptor 74. The semiconductor wafer W is held by the holder 7, assuming that a surface on which the semiconductor wafer W is to be treated is the upper surface. The back surface (a main surface opposite to the front surface) of the semiconductor wafer W supported by the substrate support pins 77 is spaced a predetermined distance apart from the holding surface 75a of the holding plate 75. The pair of transfer arms 11 moved downward below the susceptor 74 is moved back to the retracted position, i.e. to the inside of the recessed portion 62, by the horizontal movement mechanism 13.

After the semiconductor wafer W is held from below in a horizontal attitude by the susceptor 74 of the holder 7 made of quartz, the 40 halogen lamps HL in the halogen heater 4 are simultaneously turned on to start preheating (assist-heating). The halogen light emitted from the halogen lamps HL is transmitted through the bottom chamber window 64 and the susceptor 74 both made of quartz, and impinges upon the lower surface of the semiconductor wafer W. By receiving light emitted from the halogen lamps HL, the semiconductor wafer W is preheated, so that the temperature of the semiconductor wafer W is increased. The transfer arms 11 of the transfer mechanism 10, which are retracted to the inside of the recessed portion 62, do not become an obstacle to the heating using the halogen lamps HL.

The lower radiation thermometer 20 measures the temperature of the semiconductor wafer W whose temperature is increased by the light emitted from the halogen lamps HL. The measured temperature of the semiconductor wafer W is transmitted to the controller 3. The controller 3 controls the output from the halogen lamps HL while monitoring whether the temperature of the semiconductor wafer W, which is increased by the emission of light from the halogen lamps HL, reaches a predetermined preheating temperature T1. In other words, the controller 3 provides, based on a measurement value of the lower radiation thermometer 20, feedback control of the output from the halogen lamps HL so that the temperature of the semiconductor wafer W is equal to the preheating temperature T1.

After the temperature of the semiconductor wafer W reaches the preheating temperature T1, the controller 3 tentatively maintains the semiconductor wafer W at the preheating temperature T1. Specifically, the controller 3 adjusts the output from the halogen lamps HL when the temperature of the semiconductor wafer W measured by the lower radiation thermometer 20 reaches the preheating temperature T1 to maintain the temperature of the semiconductor wafer W almost at the preheating temperature T1.

By performing such preheating using the halogen lamps HL, the temperature of the entire semiconductor wafer W is uniformly increased to the preheating temperature T1. Since the temperature of the peripheral portion of the semiconductor wafer W from which heat is more easily dissipated tends to decrease more than that of the central portion thereof in the preheating phase using the halogen lamps HL, the halogen lamps HL in the halogen heater 4 are disposed at a higher density in a region facing the peripheral portion of the semiconductor wafer W than that in a region facing the central portion thereof. This allows a greater amount of light to impinge upon the peripheral portion of the semiconductor wafer W from which heat is easily dissipated, and allows the plane temperature distribution of the semiconductor wafer W in the preheating phase to be uniform.

The flash lamps FL in the flash heater 5 emit flashes of light to the front surface of the semiconductor wafer W held by the susceptor 74 after a lapse of a predetermined time period since the temperature of the semiconductor wafer W reaches the preheating temperature T1. A part of the flashes of light emitted from the flash lamps FL is directly directed into the chamber 6, and another part thereof is temporarily reflected by the reflector 52 and then directed into the chamber 6. Emission of the flashes of light initiates flash heating of the semiconductor wafer W.

Since the flash heating is performed with emission of flashes of light (flashes) from the flash lamps FL, the surface temperature of the semiconductor wafer W can be increased in a short time period. In other words, the flashes of light emitted from the flash lamps FL are intense flashes whose emission time is very short and approximately ranges from 0.1 to 100 milliseconds and which are very short light pulses transformed from the electrostatic energy accumulated in advance in the capacitors. Then, the surface temperature of the semiconductor wafer W subjected to emission of flashes of light from the flash lamps FL is instantaneously increased to the treatment temperature T2 higher than equal to 1000° C., and is then rapidly decreased.

After a lapse of a predetermined time period since the end of the flash heating treatment, the halogen lamps HL are turned off. This rapidly lowers the temperature of the semiconductor wafer W from the preheating temperature T1. The lower radiation thermometer 20 measures the decreasing temperature of the semiconductor wafer W, and transmits a result of the measurement to the controller 3. The controller 3 monitors whether the temperature of the semiconductor wafer W is lowered to a predetermined temperature, based on the result of measurement of the lower radiation thermometer 20. After the temperature of the semiconductor wafer W is lowered to a predetermined temperature or below, the pair of transfer arms 11 of the transfer mechanism 10 is moved horizontally again from the retracted position to the transfer operation position and is then moved upward, so that the lift pins 12 protrude from the upper surface of the susceptor 74 to receive the heat-treated semiconductor wafer W from the susceptor 74. Subsequently, the transport opening 66 closed by the gate valve 185 is opened, and the transport robot outside the heat treatment apparatus 1 transports the semiconductor wafer W placed on the lift pins 12 from the chamber 6. Thus, the heat treatment of the semiconductor wafer W is completed.

The heat treatment system 100 generates a model that predicts the temperature distribution occurring in the semiconductor wafer W during a light emission treatment by the heat treatment apparatus 1. The model generation by the heat treatment system 100 is broadly divided into three steps, that is, building the first learned regression model using optical simulation, building the second learned regression model based on actual measurement data, and use of the composite function 120 created by combining the models.

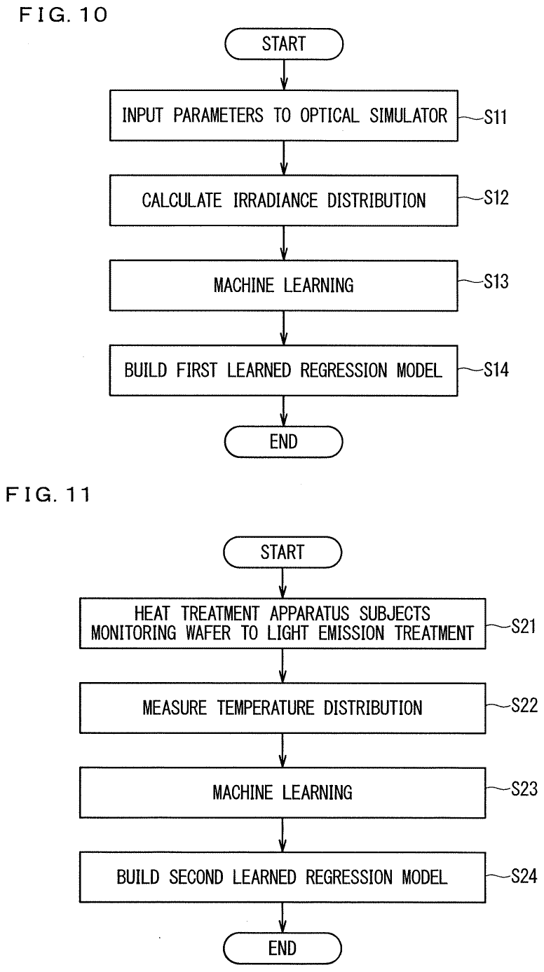

FIG. 10 is a flowchart illustrating a procedure for building the first learned regression model. Furthermore, FIG. 13 conceptually illustrates the entire treatment details of the heat treatment system 100. In FIG. 13, processes in an area enclosed by a dotted line of a sign A1 are processes for building the first learned regression model.

First, various parameters for simulation are input to the optical simulator 101 (Step S11). The optical simulator 101 executes a simulation to obtains an irradiance distribution of a light-receiving surface (back surface) of the semiconductor wafer W housed in the chamber 6 of the heat treatment apparatus 1 and held by the susceptor 74 when the 40 halogen lamps HL emit light to the semiconductor wafer W. In Step S11, various conditions on emission of light from the halogen lamps HL which are required to execute the optical simulation are input as parameters. Specifically, for example, the arrangement of the 40 halogen lamps HL, the wavelength of the light emitted from the halogen lamps HL, the shape and the optical constant of the chamber 6, the optical constant of the light-receiving surface of the semiconductor wafer W, and the input power to each of the halogen lamps HL are input to the optical simulator 101 as the parameters.

The optical simulator 101 calculates the irradiance distribution of the light-receiving surface of the semiconductor wafer W by performing the optical simulation using the input parameters (Step S12). Here, the optical simulator 101 calculates the irradiance distribution on the entire wafer surface including both of the central portion and the peripheral portion of the semiconductor wafer W.

The processes of Steps S11 and S12 are executed repeatedly a plurality of times (e.g., 200 times or more) by changing the conditions on emission of light (e.g., changing the input power to each of the halogen lamps HL). After the upper limit and the lower limit of each parameter to be input (e.g., the minimum value and the maximum value of the input power to the halogen lamp HL) are determined, combinations of treatment conditions determined by a space filling experiment plan are used as combinations of the parameters. Data sets of large-volume parameter groups and the irradiance distribution which have been obtained in such a manner become learning data for machine learning.

Next, the first regression learner 102 executes the machine learning using, as input variables, the conditions on emission of light which have been input to the optical simulator 101 in Step S11 and using, as output variables, the irradiance distribution calculated by the optical simulator 101 in Step S12 (Step S13). In other words, the first regression learner 102 learns the regression model using, as input variables, for example, measurement point coordinates, the input power to each of the halogen lamps HL, the optical constant in the chamber 6, and the optical constant of the semiconductor wafer W and using, as output variables, the irradiance distribution obtained by the optical simulation. The first regression learner 102 executes the machine learning using an algorithm such as neural networks having a regression layer, a decision tree, a support vector machine (SVM), and ensemble learning, for example.

The first regression learner 102 builds a first learned regression model 150 through the machine learning (Step S14). The first learned regression model 150 generated by the machine learning based on the learning data obtained by the optical simulation outputs the irradiance distribution occurring in the plane of the semiconductor wafer W when receiving the appropriate input values on emission of light from the halogen lamps HL. The irradiance distribution output by the first learned regression model 150 includes the illumination of the peripheral portion of the semiconductor wafer W.

Next, FIG. 11 is a flowchart illustrating a procedure for building the second learned regression model. In FIG. 13, processes in an area enclosed by a dotted line of a sign A2 are processes for building the second learned regression model.

The heat treatment apparatus 1 actually subjects a monitoring wafer to the light emission heat treatment when building the second learned regression model (Step S21). The monitoring wafer is a disk-shaped silicon wafer similarly to the semiconductor wafer W to be a product, and has the size and the shape identical to those of the semiconductor wafer W. Impurities are injected into the monitoring wafer without pattern formation or a deposition process.

The heat treatment apparatus 1 heats the monitoring wafer held by the susceptor 74 with emission of light from the 40 halogen lamps HL to the monitoring wafer. The treatment conditions when the heat treatment apparatus 1 subjects the monitoring wafer to the light emission treatment are preferably selected from a plurality of conditions used when the optical simulator 101 calculates the irradiance distribution.

The monitoring wafer subjected to the light emission heating by the heat treatment apparatus 1 is transported to the substrate measuring instrument 103. The substrate measuring instrument 103 measures a sheet resistance value of the monitoring wafer after the light emission heat treatment. The substrate measuring instrument 103 measures sheet resistance values of a plurality of portions in the plane of the monitoring wafer to obtain the in-plane distribution of the resistance values. The sheet resistance value is a function of a temperature that the monitoring wafer has reached during the light emission heat treatment. In other words, the sheet resistance values can be converted into the end-point temperature of the monitoring wafer, using a predetermined conversion equation. This brings the plane temperature distribution occurring in the monitoring wafer from a result of measurement by the substrate measuring instrument 103 during the light emission treatment by the heat treatment apparatus 1 (Step S22). Although the upper radiation thermometer 25 and the lower radiation thermometer 20 measure the temperature of the monitoring wafer subjected to the light emission heating, these radiation thermometers merely measure the temperature of a limited measurement region of the monitoring wafer. Thus, none of the radiation thermometers can obtain the plane temperature distribution.

The processes of Steps S21 and S22 are executed repeatedly on a plurality of (e.g., approximately 10) monitoring wafers under different conditions on emission of light. Data sets of the treatment conditions on emission of light and the temperature distribution actually measured, which have been obtained in such a manner, become learning data for machine learning. Preprocessing for machine learning may be performed on the learning data obtained from the actual measurement. For example, a value determined to be an outlier may be an average value obtained from a value at an adjacent coordinate and the outlier. When there is an error due to the individual difference in the substrate measuring instrument 103 or the monitoring wafer, data may be normalized.

Next, the second regression learner 104 executes the machine learning using, as input variables, the treatment conditions on emission of light performed by the heat treatment apparatus 1 and using, as output variables, the temperature distribution obtained from the actual measurement (Step S23). In other words, the second regression learner 104 learns the regression model using, as input variables, for example, measurement point coordinates, the irradiance distribution, a physical constant of the monitoring wafer, an elapsed time since start of the treatment, and the input power to each of the halogen lamps HL which changes with time and using, as output variables, the temperature distribution obtained from the actual measurement. Here, the input variables for the machine learning in Step S23 include the irradiance distribution. The irradiance distribution may be the one calculated by the optical simulation in Step S12. The second regression learner 104 also executes the machine learning using an algorithm such as the neural networks having the regression layer, the decision tree, the SVM, and the ensemble learning, for example. The input variables may include the temperature of the wafer measured by the upper radiation thermometer 25 or the lower radiation thermometer 20 as an auxiliary parameter during the light emission heat treatment on the monitoring wafer.

The second regression learner 104 builds a second learned regression model 160 through the machine learning (Step S24). The first learned regression model 150 is based on the optical simulation, whereas the second learned regression model 160 is a regression model based on the actual measurement data. The second learned regression model 160 generated by the machine learning based on the learning data obtained from the actual measurement outputs the temperature distribution occurring in the plane of the semiconductor wafer W when receiving the appropriate input values including the irradiance distribution. The temperature distribution output by the second learned regression model 160 includes the temperature of the peripheral portion of the semiconductor wafer W.

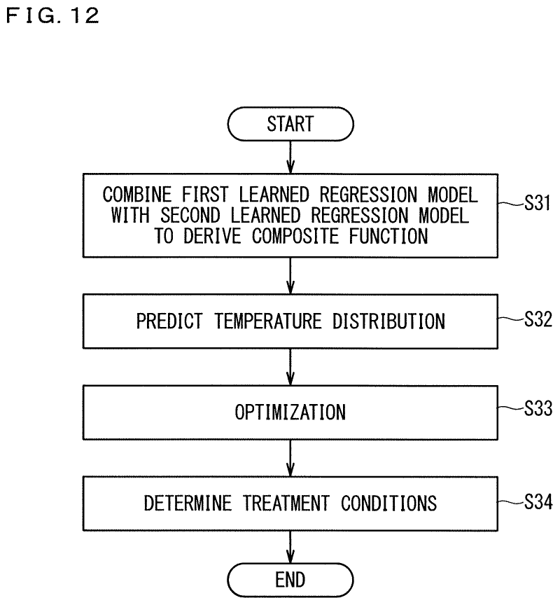

FIG. 12 is a flowchart illustrating a procedure for combining and using the first learned regression model 150 and the second learned regression model 160. Combining the first learned regression model 150 based on the optical simulation with the second learned regression model 160 based on the actual measurement data derives the composite function 120 (Step S31). For example, the controller 3 of the heat treatment apparatus 1 that has received the first learned regression model 150 and the second learned regression model 160 from the first regression learner 102 and the second regression learner 104, respectively, may derive the composite function 120, or another computer may derive the composite function 120.

The first learned regression model 150 outputs the irradiance distribution on the semiconductor wafer W using, as input variables, the conditions on emission of light from the halogen lamps HL. The second learned regression model 160 outputs the temperature distribution occurring in the semiconductor wafer W, using the treatment conditions in the heat treatment apparatus 1 including the irradiance distribution as input variables. Delivering the irradiance distribution output from the first learned regression model 150 as a part of the input variables of the second learned regression model 160 and combining the first learned regression model 150 with the second learned regression model 160 derive the composite function 120. The composite function 120 is a regression model using, as input variables, for example, the measurement point coordinates, the input power to each of the halogen lamps HL, the optical constant in the chamber 6, the optical constant of the semiconductor wafer W, and the optical constant of the monitoring wafer and using, as output variables, the temperature distribution occurring in the semiconductor wafer W. For example, the storage 34 of the controller 3 stores the generated composite function 120 (FIG. 9).

The temperature distribution predicting unit 31 of the controller 3 predicts the temperature distribution occurring in the semiconductor wafer W during the light emission heat treatment using the composite function 120, before the heat treatment apparatus 1 treats the semiconductor wafer W (Step S32). Specifically, the temperature distribution predicting unit 31 inputs the treatment conditions such as the input power to each of the halogen lamps HL, into the composite function 120 to obtain the time-series data of the temperature distribution occurring in the semiconductor wafer W. The controller 3 may display, on the display part 37, the temperature distribution of the semiconductor wafer W predicted from the composite function 120.

In this embodiment, the multi-objective optimizer 105 optimizes the treatment conditions, based on the temperature distribution of the semiconductor wafer W predicted from the composite function 120 (Step S33). The multi-objective optimizer 105 derives a difference between a target temperature distribution of the semiconductor wafer W to be treated and the temperature distribution of the semiconductor wafer W predicted from the composite function 120, as an evaluation function. The multi-objective optimizer 105 executes the multi-objective optimization such that the evaluation function at each point in time at which the temperature distribution has been predicted is the smallest to determine the input variables of the composite function 120 through an inverse operation, and determines the treatment conditions on the semiconductor wafer W to be treated (Step S34).

Execution of the heat treatment on the semiconductor wafer W by the heat treatment apparatus 1 under the treatment conditions determined in such a manner can set the temperature distribution occurring in the semiconductor wafer W to target values. The multi-objective optimizer 105 may be the controller 3 of the heat treatment apparatus 1 or another computer.

In this embodiment, combining the first learned regression model 150 created based on the optical simulation with the second learned regression model 160 created based on the actual measurement derives the composite function 120. Then, the temperature distribution occurring in the semiconductor wafer W during the light emission heat treatment is predicted from the composite function 120.

The temperature distribution occurring in the semiconductor wafer W during the light emission heat treatment is defined by the irradiance distribution and energy balance obtained by conduction of heat, convection, and radiation that are heat transfer elements. In the irradiance distribution and the energy balance, the irradiance distribution is a dominant factor that determines the temperature distribution. In this embodiment, the irradiance distribution that is a dominant factor that defines the temperature distribution is derived from the first learned regression model 150 created based on the optical simulation, and the heat transfer elements rely on the second learned regression model 160 created based on the actual measurement.

Defining a regression equation for obtaining the temperature distribution of the semiconductor wafer W only from the actual measurement consumes a large number of monitoring wafers. In this embodiment, the irradiance distribution that is a dominant factor that defines the temperature distribution is derived from the first learned regression model 150 created based on the optical simulation, and only the heat transfer elements rely on the second learned regression model 160 created based on the actual measurement. Thus, the monitoring wafers to be consumed can be significantly reduced.

Since the irradiance distribution is derived from the first learned regression model 150 created based on the optical simulation, the irradiance distribution of the peripheral portion of the semiconductor wafer W can be accurately obtained. Consequently, the prediction accuracy of the temperature distribution in the peripheral portion of the semiconductor wafer W can be enhanced. In other words, this embodiment can simply predict the temperature distribution occurring in the semiconductor wafer W with high accuracy.

While the embodiment according to the present invention is described above, various modifications in addition to those described above can be made without departing from the scope and spirit of the invention. For example, the controller 3 may sequentially give the composite function 120 input variables in real time during an actual light emission heat treatment of the semiconductor wafer W to cause the composite function 120 to output a temperature prediction value at any coordinates of the semiconductor wafer W, and perform feedback control of the temperature of the semiconductor wafer W based on the temperature prediction value. Specifically, the controller 3 controls the output of the halogen lamps HL such that the temperature prediction value obtained from the composite function 120 becomes a predetermined target value. In other words, the controller 3 performs the control, assuming that the composite function 120 is a virtual temperature sensor. This enables the temperature control at a coordinate position of the semiconductor wafer W which cannot be measured by the upper radiation thermometer 25 or the lower radiation thermometer 20.

Furthermore, the upper radiation thermometer 25 or the lower radiation thermometer 20 actually measures the temperature of the semiconductor wafer W during the light emission heat treatment, and the controller 3 obtains a temperature prediction value at the measurement point coordinates from the composite function 120. Then, the controller 3 may compare the actual measured value by the upper radiation thermometer 25 or the lower radiation thermometer 20 with the temperature prediction value output from the composite function 120, and learn the composite function 120 again such that the actual measured value is equal to the temperature prediction value. In other words, the composite function 120 learns again, using the actual measured value by the upper radiation thermometer 25 or the lower radiation thermometer 20 as training data.

Although the flash heater 5 includes the 30 flash lamps FL in the embodiment, the number of the flash lamps FL is not limited to this but can be any. Furthermore, the flash lamps FL are not limited to xenon flash lamps but may be krypton flash lamps. The number of the halogen lamps HL included in the halogen heater 4 is not limited to 40 but can be any.

The filament-type halogen lamps HL as continuous lighting lamps that emit light continuously for not less than one second subject the semiconductor wafer W to a preheat treatment in this embodiment. The continuous lighting lamps are not limited to the halogen lamps HL. Instead of the halogen lamps HL, discharge-type arc lamps (e.g., xenon arc lamps) or LED lamps may be used as the continuous lighting lamps to subject the semiconductor wafer W to the preheat treatment.

### EXPLANATION OF REFERENCE SIGNS

1 heat treatment apparatus
3 controller
4 halogen heater
5 flash heater
6 chamber
7 holder
10 transfer mechanism
20 lower radiation thermometer
25 upper radiation thermometer
31 temperature distribution predicting unit
63 top chamber window
64 bottom chamber window
65 heat treatment space
74 susceptor
100 heat treatment system
101 optical simulator
102 first regression learner
103 substrate measuring instrument
104 second regression learner
105 multi-objective optimizer
120 composite function
150 first learned regression model
160 second learned regression model
FL flash lamp
HL halogen lamp
W semiconductor wafer

1. A heat treatment method for heating a substrate by emitting light to the substrate, the method comprising:
an irradiance distribution calculation step of calculating an irradiance distribution on a substrate by an optical simulation, based on a condition on emission of light from a lamp;
a first learning step of building a first learned model by machine learning, using the condition on the emission of the light as an input variable and using the irradiance distribution calculated by the optical simulation as an output variable;
a temperature distribution measuring step of measuring a temperature distribution occurring in a monitoring substrate when the lamp emits the light to the monitoring substrate;
a second learning step of building a second learned model by machine learning, using a treatment condition in the temperature distribution measuring step as an input variable and using the temperature distribution measured in the temperature distribution measuring step as an output variable, the treatment condition including the irradiance distribution;
a combining step of delivering the irradiance distribution output from the first learned model as a part of the input variable of the second learned model, and combining the first learned model with the second learned model to derive a composite function; and
a temperature distribution predicting step of predicting, based on the composite function, a temperature distribution occurring in a substrate to be treated when the lamp emits the light to the substrate to be treated.

2. The heat treatment method according to claim 1,
wherein an output of the lamp is controlled based on a temperature prediction value predicted in the temperature distribution predicting step.

3. The heat treatment method according to claim 1,
wherein a treatment condition on the substrate to be treated is determined such that an evaluation function is smallest, the evaluation function being a difference between a target temperature distribution of the substrate to be treated and the temperature distribution predicted in the temperature distribution predicting step.

4. A heat treatment system that heats a substrate by emitting light to the substrate, the system comprising:
an optical simulator that calculates an irradiance distribution on a substrate by an optical simulation, based on a condition on emission of light from a lamp;
a first learner that builds a first learned model by machine learning, using the condition on the emission of the light as an input variable and using the irradiance distribution calculated by the optical simulation as an output variable;
a temperature distribution measuring instrument that measures a temperature distribution occurring in a monitoring substrate when the lamp emits the light to the monitoring substrate in a heat treatment apparatus; and
a second learner that builds a second learned model by machine learning, using a treatment condition when the lamp emits the light to the monitoring substrate as an input variable and using the temperature distribution measured by the temperature distribution measuring instrument as an output variable, the treatment condition including the irradiance distribution,
wherein the heat treatment system predicts, based on a composite function, a temperature distribution occurring in a substrate to be treated when the lamp emits light to the substrate to be treated in the heat treatment apparatus, the composite function being derived by delivering the irradiance distribution output from the first learned model as a part of the input variable of the second learned model and combining the first learned model with the second learned model.

5. The heat treatment system according to claim 4,
wherein an output of the lamp is controlled based on a temperature prediction value predicted to occur in the substrate to be treated.

6. The heat treatment system according to claim 4,
wherein a treatment condition on the substrate to be treated is determined such that an evaluation function is smallest, the evaluation function being a difference between a target temperature distribution of the substrate to be treated and a temperature distribution predicted to occur in the substrate to be treated.

7. A heat treatment apparatus that heats a substrate by emitting light to the substrate, the apparatus comprising:
a chamber that houses a substrate;
a holder that holds the substrate in the chamber;
a lamp that emits light to the substrate held by the holder; and
a controller that controls an output of the lamp,
wherein the controller predicts, based on a composite function, a temperature distribution occurring in a substrate to be treated in the chamber when the lamp emits the light to the substrate to be treated, the composite function being derived by combining a first learned model with a second learned model, the first learned model being built by machine learning using a condition on the emission of the light from the lamp as an input variable and using an irradiance distribution calculated by an optical simulation based on the condition as an output variable, the second learned model being built by machine learning using a treatment condition when the lamp emits the light to a monitoring substrate in the chamber as an input variable and using a temperature distribution occurring in the monitoring substrate as an output variable.

8. The heat treatment apparatus according to claim 7,
wherein the composite function is derived by delivering the irradiance distribution output from the first learned model as a part of the input variable of the second learned model, and combining the first learned model with the second learned model.

9. The heat treatment apparatus according to claim 7,
wherein the controller controls an output of the lamp based on a temperature prediction value predicted to occur in the substrate to be treated.

10. The heat treatment apparatus according to claim 7,
wherein the controller determines a treatment condition on the substrate to be treated such that an evaluation function is smallest, the evaluation function being a difference between a target temperature distribution of the substrate to be treated and a temperature distribution predicted to occur in the substrate to be treated.
